(19) United States
(12) Patent Application Publication
(10) Pub. No.: US 2012/0044310 A1
(43) Pub. Date: Feb. 23, 2012

(54) POSITION ADJUSTMENT MECHANISM AND RECORDING APPARATUS

(75) Inventors: Yasushi Yajima, Minowa-machi (JP); Daisuke Hiruma, Matsumoto-shi (JP); Ryo Hamano, Matsumoto-shi (JP); Norihito Harada, Azumino-shi (JP)

(73) Assignee: SEIKO EPSON CORPORATION, Tokyo (JP)

(21) Appl. No.: 13/212,134

(22) Filed: Aug. 17, 2011

(30) Foreign Application Priority Data
Aug. 18, 2010 (JP) 2010-183103

(51) Int. Cl. B41J 2/01; F16H 25/08

(52) U.S. Cl. 347/104; 74/55

(57) ABSTRACT

A position adjustment mechanism is provided to adjust a position of second member with respect to a first member. The position adjustment mechanism includes: a cam that is provided in the first member so that a cam surface of the cam abuts the second member; and a fixing portion that is provided in a forming area of the cam surface in the first member and fixes the second member to the first member by screw in a state where the position of the second member with respect to the first member is adjusted by the cam.

The entire disclosure of Japanese Patent Application No: 2010-183103, filed Aug. 18, 2010 is expressly incorporated by reference herein in its entirety.

### BACKGROUND

1. Technical Field

The present invention relates to a position adjustment mechanism and a recording apparatus.

2. Related Art

In general, as a recording apparatus in which a liquid is adhered to a recording medium and a recording processing is performed, an ink jet type printer is widely known in which ink (liquid) is ejected from each nozzle of a recording head mounted on a carriage to the recording medium and the printing is performed (for example, JP-A-2010-125832). In the above-described printer, in order to secure the printing accuracy, the position of the recording head with respect to the carriage is adjusted. That is, in the printer of JP-A-2010-125832, a sliding member which slides on a head unit (a recording portion) and defines the inclination angle of the head unit, and an adjustment eccentric cam which is engaged to the sliding member are provided. In addition, the inclination angle of the head unit is defined through the sliding member due to a fact that the adjustment eccentric cam is rotated.

However, in the printer of JP-A-2010-125832, after the inclination angle of the head unit is adjusted through the sliding member due to the rotation of the adjustment eccentric cam, the position of the sliding member is fixed by fixing screws (screws). Therefore, although the inclination angle of the head unit is held to an appropriate angle, the fixing position of the sliding member, which is fixed by the fixing screws, is separated from the adjustment eccentric cam. Thereby, the fixing position of the sliding member is deviated due to the fastening through the fixing screws, and there is a problem in that the inclination angle of the head unit may be deviated.

### SUMMARY

An advantage of some aspects of the invention is to provide a position adjustment mechanism and a recording apparatus capable of accurately holding a first member and a second member in a state where a position of the second member with respect to the first member is adjusted.

According to aspect of the invention, there is provided a position adjustment mechanism that adjusts a position of a second member with respect to a first member, the position adjustment mechanism including: a cam that is provided in the first member so that a cam surface of the cam abuts the second member; and a fixing portion that is provided in a forming area of the cam surface in the first member and fixes the second member to the first member by screw in a state where the position of the second member with respect to the first member is adjusted by the cam.

According to the aspect of the invention, in the state where the position of the second member with respect to the first member is adjusted by the cam, when the second member is fixed by the screw to the fixing portion which is provided in the forming area of the cam surface of the cam in the first member, the abutment position of the cam surface of the cam and the fixing position fixed by the screw come very close to each other in the second member. Therefore, it is possible to accurately hold the first member and the second member in a state where the position of the second member with respect to the first member is adjusted.

In the position adjustment mechanism of the aspect of the invention, three cams may be provided, and each cam may be disposed so as to line up in a non-liner shape in positions which are different to each other in the first member.

According to the position adjustment mechanism of the aspect of the invention, it is possible to accurately adjust the position of the second member with respect to the first member by each cam.

In the position adjustment mechanism of the aspect of the invention, the cam may be annularly formed and the fixing portion may be disposed so that an outer peripheral surface of the fixing portion comes close to an inner peripheral surface of the cam.

According to the position adjustment mechanism of the aspect of the invention, since the second member is fastened to the first member in the fixing portion by the screw, even though the cam tends to fall inward, it is possible to support the cam from the inside by the fixing portion.

In the position adjustment mechanism of the aspect of the invention, the cam may be annularly formed and a rotary cam which is rotated about a shaft installed so as to cross to an axis direction of the screw in the outer peripheral surface of the cam. In addition, the position adjustment mechanism may be further provided with a bearing portion that is installed in the first member and supports the shaft, and the bearing portion may be disposed so that a surface of the cam side comes close to the outer peripheral surface of the cam.

According to the position adjustment mechanism of the aspect of the invention, since the second member is fastened to the first member by the screw in the fixing portion, even though the cam tends to fall outward, it is possible to support the cam from the outside by the bearing portion.

According to another aspect of the invention, there is provided a recording apparatus including: the adjustment mechanism of the above-described configuration; and a recording portion that performs a recording processing on a recording medium which is transported from the upstream side toward the downstream side, wherein the first member constitutes a carriage that is moved in a scanning direction intersecting the transport direction of the recording medium, the second member constitutes the recording portion, each cam is disposed at two positions that are separated along the scanning direction on the upstream side of the transport direction in the carriage, and at one position between the two positions in the scanning direction at the downstream side in the transport direction in the carriage, the shafts of the cams disposed in the two positions are extended along the scanning direction, and the shaft of the cam disposed in the one position is extended along the transport direction.

In general, since the carriage is supported so as to be movable in a guide shaft in which the end of the upstream side in the transport direction of the recording medium in the carriage is extended in the scanning direction, a space capable of installing components in a side surface of the guide shaft side in the carriage is not substantially provided. With regard to this, according to the recording apparatus of the aspect of the invention, since each member for rotating the cam shaft can be installed in the both side surfaces in the scanning direction in the carriage and the side surface of a side which is opposite to the guide shaft side in the carriage, each cam can be easily rotated by operating each member.

In the recording apparatus of the aspect of the invention, the recording portion may include a nozzle forming area of a plane shape in which the nozzle is formed so as to eject a liquid to the recording medium, and each cam may be disposed on the outside of the nozzle forming area in a direction crossing the nozzle forming area.

According to the recording apparatus of the aspect of the invention, it is possible to accurately adjust the position of the recording portion so that the nozzle forming area is parallel to a recording surface of the recording medium by each cam.

### BRIEF DESCRIPTION OF THE DRAWINGS

The invention will be described with reference to the accompanying drawings, wherein like numbers reference like elements.

FIG. 1 is a perspective view showing an ink jet type printer of an embodiment.

FIG. 2 is an exploded perspective view showing a carriage and a recording unit which is mounted on the carriage in a state of removing an upper cover of the printer.

FIG. 3 is a schematic plan view showing a position relationship between the recording unit and the carriage in the printer.

FIG. 4 is an enlarged perspective view showing a main portion of an inner portion of the carriage.

FIG. 5 is an enlarged perspective view showing a main portion of an outer portion of the carriage.

FIG. 6 is a plan view showing a cam in the printer.

FIG. 7 is a perspective view of FIG. 6.

FIG. 8 is a side view of FIG. 6.

FIG. 9 is an enlarged main portion cross-section view showing a state when a recording unit is fixed to the carriage by screw in the printer.

### DESCRIPTION OF EXEMPLARY EMBODIMENTS

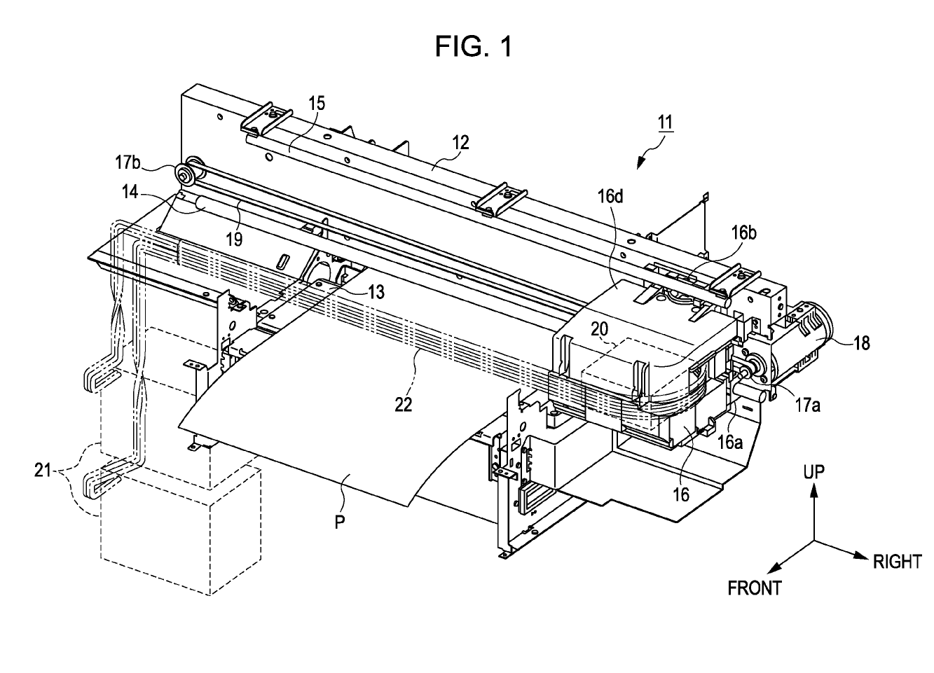

Hereinafter, one embodiment in which the invention is exemplified by an ink jet type printer will be described with reference to the accompanying drawings. In addition, in the description below, “the front-back direction”, “the left-right direction”, and “the up-down direction” each indicate the front-back direction, the left-right direction, and the up-down direction which are indicated by arrows in FIG. 1.

As shown in FIG. 1, the ink jet type printer 11 as a recording apparatus includes a main body frame 12. In the lower portion of the main body frame 12, a supporting frame 13 is extended and installed along the left-right direction which is the longitudinal direction of the main body frame 12. On the supporting frame 13, a recording sheet P serving as a recording medium is transported by a sheet-feeding mechanism (not shown) along a direction (a transport direction: a secondary scanning direction) which faces from a backward side being the upstream side to a forward side being the downstream side.

In the upside of the supporting frame 13 in the main body frame 12, a main guide shaft 14 is extended and installed along the longitudinal direction (the left-right direction) of the supporting frame 13. Moreover, in the upside of the main guide shaft 14 in the main body frame 12, a secondary guide shaft 15 is extended and installed in parallel to the main guide shaft 14. In the main guide shaft 14, a carriage 16 as a first member is supported so as to reciprocate along an axis direction (the left-right direction) of the main guide shaft 14.

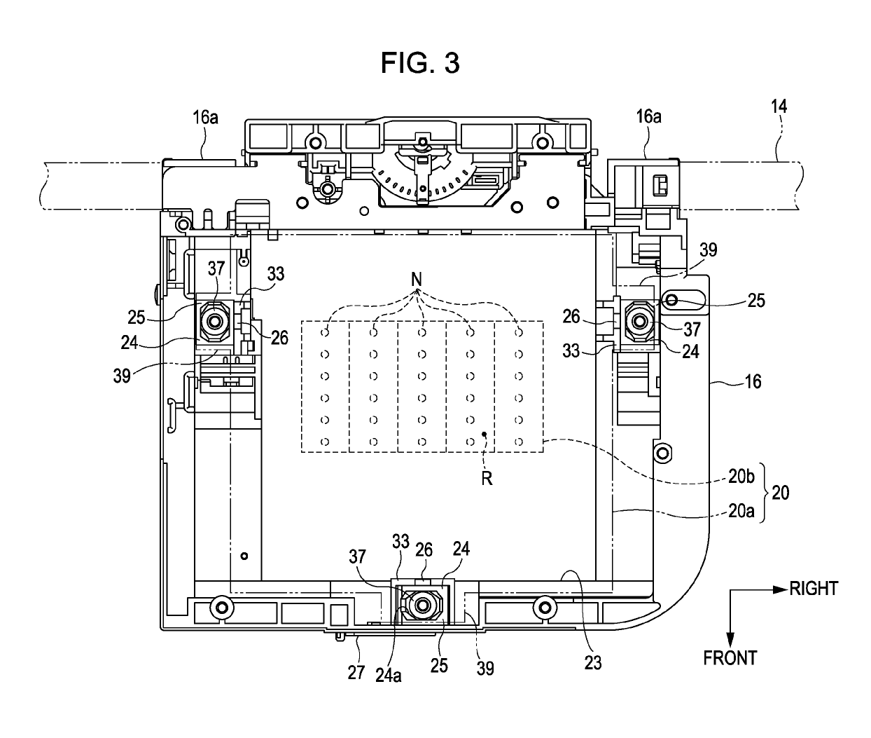

That is, a pair of guide portions 16a (refer to FIG. 3), which are each installed in the left and the right, are provided in a lower portion of a rear surface of the carriage 16. Moreover, the main guide shaft 14 is slidably fitted to each guide portion 16a. In addition, an engaging portion 16b, which is slidably engaged to the secondary guide shaft 15 from the rear side of the secondary guide shaft 15, is provided in an upper portion of a rear end of the carriage 16. Moreover, the engaging portion 16b abuts the secondary guide shaft 15 while always applying load to the secondary guide shaft 15 due to the weight of the carriage 16 itself.

In a position of the slight upside of both ends of the main guide shaft 14 in the main frame 12, a driving pulley 17a and a driven pulley 17b are rotatably supported. An output shaft of a carriage motor 18 is connected to the driving pulley 17a and the carriage motor 18 serves as a driving source when reciprocating the carriage 16 along the main guide shaft 14.

In addition, an endless timing belt 19 is hung between both pulleys 17a and 17b, and a portion of the endless timing belt 19 is connected to the carriage 16. Therefore, the carriage 16 is reciprocated in the left-right direction (a primary scanning direction) via the endless timing belt 19 by the driving force of the carriage motor 18 while being guided in the main guide shaft 14 and the secondary guide shaft 15.

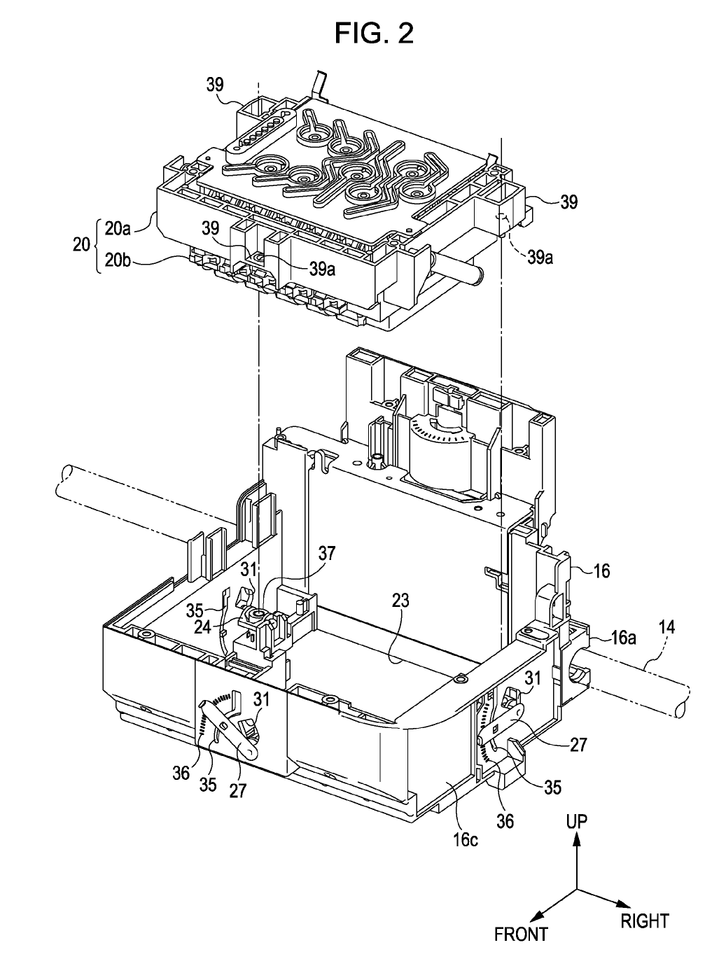

As shown in FIGS. 1 and 2, the carriage 16 is formed in an approximately rectangular frame shape, and an upper cover 16d is detachably attached to the upside of the carriage 16. Moreover, a recording head unit 20 is supported (accommodated) in the inner portion of the carriage 16, and the recording head unit 20 serves as a recording portion which constitutes a second member. The recording head unit 20 includes a sub-carriage 20a of an approximately rectangular frame shape and a recording head 20b which is attached to the inside of the sub-carriage 20a.

The lower surface of the recording head 20b is constituted from a nozzle forming area R of a plane shape in which a plurality nozzles N (refer to FIG. 3) is opened. In addition, an ink tank 21, which is charged with inks of each color in the inner portion thereof, is disposed at the lower left side of the main body frame 12. The ink tank 21 is connected to the recording head unit 20, which is supported to the carriage 16, via a flexible ink supply tube 22. Therefore, the inks of each color in the ink tank 21 are supplied to the recording head unit 20 via the ink supply tube 22.

In addition, the carriage 16 is reciprocated in the left-right direction (the primary scanning direction), which is perpendicular to the transport direction of the recording sheet P, along the main guide shaft 14. At the same time, the inks of each color, which are supplied from the ink tank 21 to the recording head unit 20, are ejected to the fed recording sheet P from each of the nozzles N of the recording head 20b (refer to FIG. 3) to the supporting frame 13, and therefore, printing is performed.

Next, a configuration of the carriage 16 will be described.

As shown in FIGS. 2 and 3, when the carriage 16 supports the recording head unit 20, the carriage 16 exposes a recording head 20b to an opening 23 of the bottom in the carriage 16. On both the left side and right side of the carriage 16 which interposes the opening 23 on the rear end side of the bottom in the carriage 16 and a center portion in the left-right direction on the front end side of the bottom in the carriage 16, rotary cams 24 for adjusting the position of the recording head unit 20 with respect to the carriage 16 are each rotatably disposed.

That is, each cam 24 is disposed in two positions which are separated along the primary scanning direction on the upstream side of the transport direction of the recording sheet P (refer to FIG. 1) in the carriage 16. In addition, each cam 24 is disposed in one position which is between the two positions in the primary scanning direction on the downstream side of the transport direction of the recording sheet P in the carriage 16. In other words, in the outer side of the opening 23 in the bottom within the carriage 16, three cams 24 are each disposed so as to draw (line up in a non-linear shape) a triangle in planar view when linearly connecting the cams 24 to one another. Therefore, each cam 24 is disposed on the outside of the nozzle forming area R in the up-down direction which is perpendicular to the nozzle forming area R.

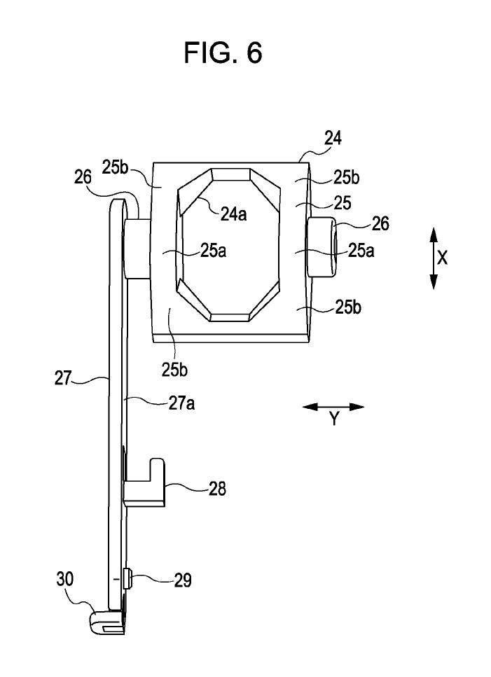

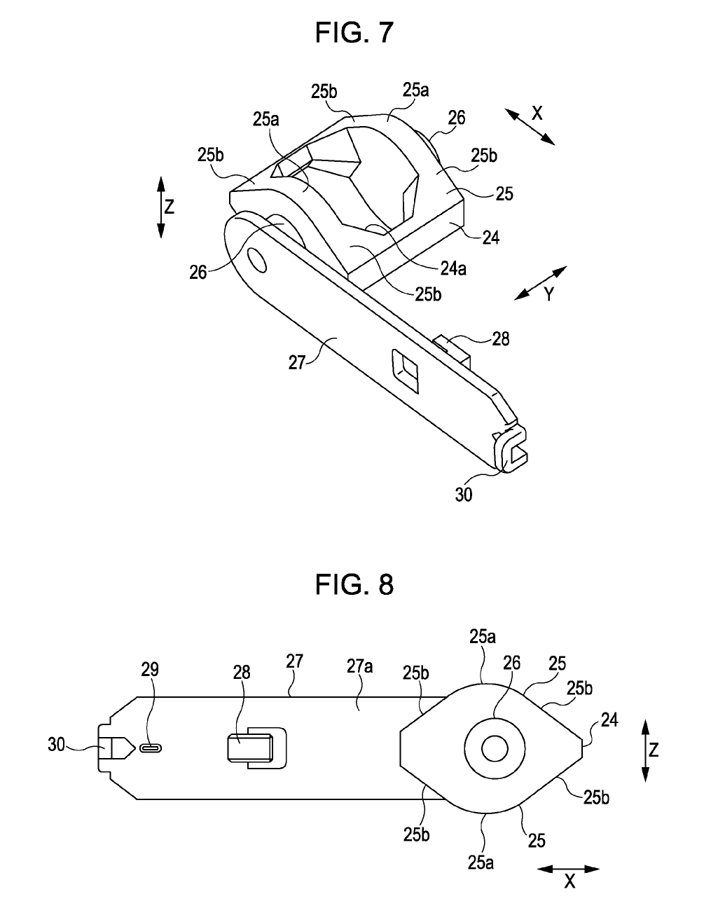

Here, a configuration of the cam 24 will be described with reference to FIGS. 6 to 8.

First, in FIGS. 6 to 8, the longitudinal direction of the cam 24 is given as the X-direction, the lateral direction of the cam 24 is given as the Y-direction, and the thickness direction of the cam 24 is given as the Z-direction.

As shown in FIGS. 6 to 8, the cam 24 includes an opening 24a in the inner portion of the cam and is formed in an annularly rectangular shape in planar view. A front surface (a surface of one side) of the cam 24 and a rear surface (a surface of the other one side) of the cam 24 each become cam surfaces 25, and the front surface and the rear surface of each cam surface 25 are symmetric to each other. In each cam surface 25, a center portion in the X-direction is expanded outward in the Z-direction and become an arc portion 25a which constitutes an arc-shaped surface. In addition, each cam surface 25 is inclined so that the thickness of the cam 24 gradually decreases from the arc portion 25a to both ends in the X-direction, and becomes flat surface 25b.

In a position which is slightly deviated in the X-direction from the center portion of both side surfaces (outer peripheral surfaces) in the Y-direction of the cam 24, shafts 26 serving as center in the rotation of each cam 24 are each protruded and installed in the Y-direction so as to be opposite to each other. That is, each cam 24 becomes an eccentric cam in which each shaft 26 is eccentric. In the tip of the shaft 26 of one side of each shaft 26, a lever member 27 for rotating the cam 24 about the shaft 26 is installed. That is, in the tip of the shaft 26 of one side of each shaft 26, one end of the shaft 26 is connected to one side surface 27a of the lever member 27 of an approximately rectangular plate shape which is extended in the X-direction.

In a position which is slightly nearer to the other end side from the center portion in the X-direction in one side surface 27a of the lever member 27, a guide piece 28 is protruded and installed. Moreover, the tip portion of the guide piece 28 is formed in an L-shape so as to be perpendicularly bent to the cam 24 side in the X-direction. In the other end portion in the X-direction in the one side surface 27a of the lever member 27, an approximately elliptical protrusion 29 is installed. In addition, in the other end in the X-direction of the lever member 27, a handle 30 is extended and installed so as to grasp the lever member 27 when rotating the cam 24 through the lever member 27. The handle 30 is extended and installed toward the side which is opposite to the cam 24 side in the Y-direction.

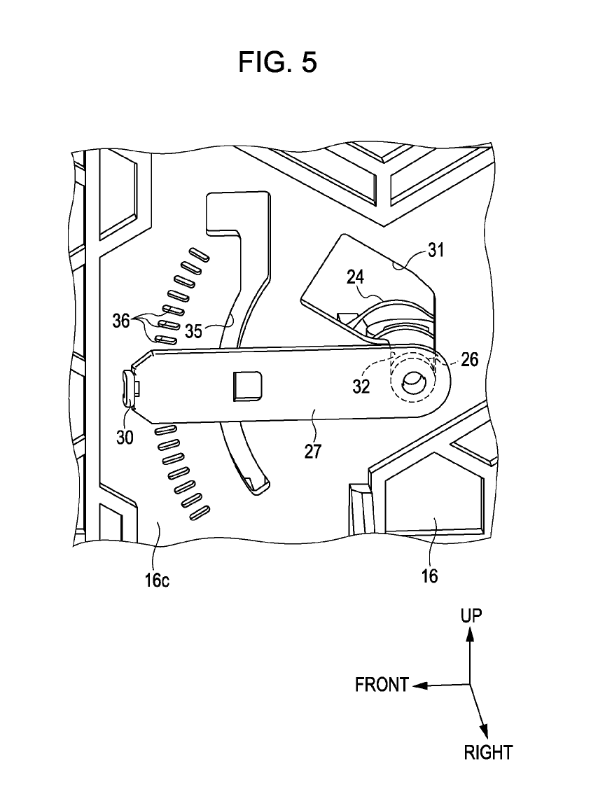

As shown in FIGS. 2 and 3, each cam 24 is disposed so as to be adjacent to a peripheral wall 16c of the carriage 16. In addition, penetration holes 31 each are formed in the peripheral wall 16c, and the shaft 26 of the one side in which the lever member 27 of each cam 24 is installed is inserted into the penetration holes 31. In addition, a lower end portion of each penetration holes 31 becomes a bearing portion 32 (refer to FIG. 5), and the bearing portion 32 is formed in a U-shape and supports the shaft 26 of the one side in which the lever member 27 of each cam 24 is installed. In addition, the lever member 27 of each cam 24 is extended along the outside of the peripheral wall 16c of the carriage 16.

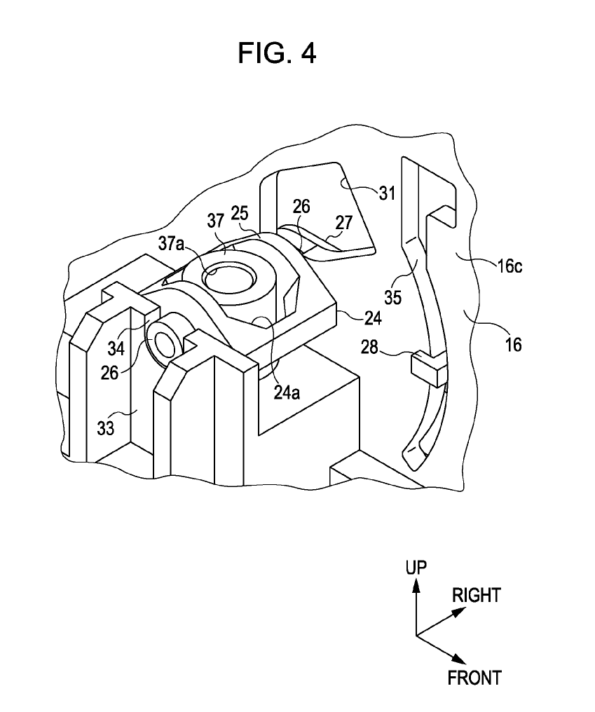

As shown in FIGS. 2 to 5, a bearing plate 33 each is erected in a position which faces each bearing portion 32 by interposing each cam 24 in the carriage 16. Each bearing portion 34 is installed in an upper end portion of each bearing plate 33, and the bearing portion 34 is formed in a U-shape and supports the shaft 26 of the other one side in which the lever member 27 of each cam 24 is not installed. In this case, each bearing portion 32 and each bearing portion 34 correspond to each other in the axis direction of the corresponding cam 24. Therefore, each cam 24 is disposed in the carriage 16 in a state where each shaft 26 is supported by each bearing portion 32 and each bearing portion 34.

In this case, in the peripheral wall 16c in which each bearing portion 32 is installed and each bearing plate 33 in which each bearing portion 34 is installed, the surface of each cam 24 side of the peripheral wall 16c and each bearing plate 33 come close to the surface (the outer peripheral surface) in which each shaft 26 is installed in each cam 24. Moreover, in this case, two cams 24, which are disposed in the rear end side in the carriage 16 among the cams 24, are disposed so that each shaft 26 of the two cams 24 is horizontally extended along the left-right direction. In addition, one cam 24, which is disposed in the front end side in the carriage 16 among the cams 24, is disposed so that each shaft 26 of the one cam 24 is horizontally extended along the front-back direction.

In positions which face the guide piece 28 and the protrusion 29 of the lever member 27 of each cam 24 in the peripheral wall 16c of the carriage 16, a long slot 35 and a plurality of fitting holes 36 are formed so as to penetrate the peripheral wall 16c. Each long slot 35 is an arc shape extended to follow a track of each guide piece 28 when each lever member 27 is rotated about the shaft 26 of each cam 24. Moreover, the guide piece 28 of each lever member 27 is slidably engaged to each long slot 35.

In addition, each fitting hole 36 is disposed in an arc shape in a regular interval (pitch) so as to follow a track of each protrusion 29 when each lever member 27 is rotated about the shaft 26 of each cam 24. In addition, the protrusion 29 of each lever member 27 is detachably fitted to each fitting hole 36. Therefore, since the lever member 27 is rotated and the protrusion 29 of the lever member 27 is selectively fitted to any one of the fitting holes 36, the rotation angle of the cam 24 about the shaft 26 is changed in stages.

As shown in FIGS. 3, 4 and 9, in the inside of each cam 24 in the bottom in the carriage 16, that is, in an opening 24a of each cam 24, each columnar boss portion 37 serving as a fixing portion is erected. Screw hole 37a is formed on an upper surface of each boss portion 37. The outer peripheral surface of each boss portion 37 comes close to the inner peripheral surface of each cam in the direction in which the shaft 26 of each cam 24 is extended. In addition, the upper end surface of each boss portion 37 is set to be lower than the highest position in the cam surface 25 of each cam 24.

Moreover, in the embodiment, the inner area of the cam 24 in the carriage 16, that is, the area in the opening 24a constitutes a cam forming area. In addition, each cam 24, each boss portion 37, and the bearing portions 32 and 34 constitute a position adjustment mechanism.

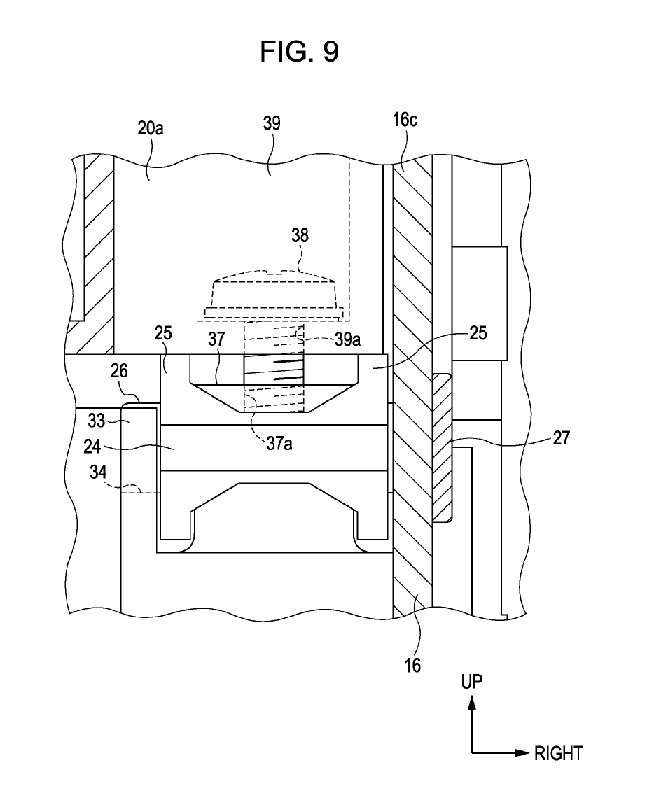

As shown in FIGS. 2 and 9, a fixed portion 39, which is fixed to each boss portion 37 of the carriage 16 by screw 38, is installed in the sub-carriage 20a so as to correspond to each cam 24. In each fixed portion 39, an insertion hole 39a into which the screw 38 is inserted into is installed so as to correspond to each boss portion 37.

In addition, in a state where the screw 38 is inserted into the insertion hole 39a of each fixed portion 39 of the sub-carriage 20a, each screw 38 is screwed into and tightened to the screw hole 37a of each boss portion 37 of the carriage 16. Therefore, the sub-carriage 20a is fixed to the carriage 16. In this case, the axis direction (the up-down direction) of each screw 38 is perpendicular to the direction (the left-right direction and the front-back direction) in which each shaft 26 of each cam 24 is extended.

Next, when the recording head unit 20 is fixed to the carriage 16, the operation will be described.

When the recording head unit 20 is fixed to the carriage 16, first, the recording head unit 20 is placed (accommodated) in the carriage 16. Thereby, the lower surface of each fixed portion 39 of the sub-carriage 20a abuts on the cam surface 25 of each cam 24. In this time, the inserting hole 39a of each fixed portion 39 is opposite (corresponding) to the screw hole 37a of each boss portion 37 in the up-down direction.

Here, in general, each part constituting the carriage 16 or the recording head unit 20 has variations in the size. Therefore, in the state where the recording head unit 20 is placed in the carriage 16, the height or the angle of the recording head unit 20 varies. Thus, in the above-described state, if the recording head unit 20 is fixed into the carriage 16, the distance between the nozzle forming area R of the recording head 20b and the printing surface of the recording sheet P varies, or the nozzle forming area R of the recording head 20b and the printing surface of the recording sheet P are not parallel to each other. Therefore, the printing accuracy of the printing sheet P is decreased. Thus, after the recording head unit 20 is placed in the carriage 16, it is necessary to adjust the height or the angle of the recording head unit 20.

Therefore, in the embodiment, the lever member 27 of each cam 24 is rotated and each cam 24 is rotated about the shaft 26. Thus, the abutment position of the recording head unit 20 in the cam surface 25 of each cam 24 is adjusted. That is, in this case, the abutment position of the recording head unit 20 in the cam surface 25 of each cam 24 in which the recording head unit 20 is supported at three points is adjusted so that the distance between the nozzle forming area R of the recording head 20b and the printing surface of the recording sheet P is a preset value and the nozzle forming area R and the printing surface of the recording sheet P are parallel to each other.

Thereby, the position (the height and the angle) of the recording head unit 20 becomes the adjusted state in the carriage 16. While maintaining the above state, in a state where each screw 38 is inserted into the insertion hole 39a of each fixed portion 39, each screw 38 is screwed into and tightened to the screw hole 37a of each boss portion 37. Therefore, the recording head unit 20 is fixed into the carriage 16 in the state where the position of the recording head unit 20 is adjusted in the carriage 16.

In this time, the upper portions of the side walls of both sides in the axis direction of each cam 24 tend to fall inward due to the tightening force of each screw 38, and the lower portion of each side wall tends to fall outward. However, the side walls of both sides in the axis direction of each cam 24 are supported from the inside by each boss portion 37. Moreover, the side walls are supported from the outside by the peripheral wall 16c (each bearing portion 32) of the carriage 16 and each bearing plate 33 (each bearing portion 34). Therefore, a collapse of the position adjustment state of the recording head unit 20 in the carriage 16 due to the tightening force of each screw 38 is suppressed.

According to above-described embodiment, the following effects can be obtained.

(1) In the state where the position (the height and the angle) of the recording head unit 20 is adjusted by each annular cam 24 in the carriage 16, the recording head unit 20 is tightened and fixed to each boss portion 37 which is in the inside of each cam 24 by each screw 38. That is, in the recording head unit 20, the abutment position of the cam surface 25 of each cam 24 and the tightening position which is tightened by each screw 38 come very close to each other. Therefore, the difference between the position aspect of the recording head unit 20 when the position is adjusted in the carriage 16 and the position aspect of the recording head unit 20 when the recording head unit 20 is tightened and fixed by each screw 38 in the carriage 16 can be small. Therefore, the collapse of the position adjustment state of the recording head unit 20 in the carriage 16 due to the tightening force of each screw 38 is suppressed. Therefore, it is possible to accurately hold the carriage 16 and the recording head unit 20 in the state where the position of the recording head unit 20 with respect to the carriage 16 is adjusted.

(2) Three cams 24, which support the recording head unit 20, are each disposed so as to draw a triangle (line up in the non-linear shape) in planar view when linearly connecting the cams 24 to one another. Therefore, due to the fact that each cam 24 is rotated, the position (the height and the angle) of the recording head unit 20 with respect to the carriage 16 can be accurately and freely adjusted.

(3) Each boss portion 37 is disposed so that the outer peripheral surface of each boss portion 37 comes close to the side walls of both sides in the axis direction of each cam 24 in the inside of each cam 24. Therefore, due to the fact that the recording head unit 20 is tightened to each boss portion 37 in the carriage 16 by each screw 38, even though the side walls of both sides in the axis direction of each cam 24 tend to fall inward, each side walls can be supported from the inside by each boss portion 37.

(4) In the peripheral wall 16c of the carriage 16 in which each bearing portion 32 is installed and each bearing plate 33 in which each bearing portion 34 is installed, the surface of each cam 24 side of the peripheral wall 16c and each bearing plate 33 come close to the surface (the outer peripheral surface) in which each shaft 26 is installed in each cam 24. Therefore, since the recording head unit 20 is fastened to each boss portion 37 in the carriage 16 by each screw 38, even though the side walls of both sides in the axis direction of each cam 24 tend to fall outward, each side walls can be supported from the outside by the peripheral wall 16c (each bearing portion 32) of the carriage 16 and each bearing plate 33 (each bearing 34).

(5) Two cams 24 of the cams 24, which are disposed in the rear end side in the carriage 16, are disposed so that each shaft 26 of two cams 24 is horizontally extended along the left-right direction. In addition, one cam 24 of the cams 24, which is disposed in the front end side in the carriage 16, is disposed so that each shaft 26 of the one cam 24 is horizontally extended along the front-back direction. Therefore, in both side surfaces and front surface of the left-right direction (the primary scanning direction) in the carriage which is not opposite to the main guide shaft 14, the lever member 27 for rotating the shaft 26 of each cam 24 can be installed. Each cam 24 can be easily rotated by operating each lever member 27.

(6) Since each cam 24 is disposed on the outside of the nozzle forming area R in the direction (the up-down direction) which is perpendicular to the nozzle forming area R, the position of the recording head unit 20 can be accurately adjusted so that the nozzle forming area R is parallel to the recording surface of the recording sheet P by each cam 24.

(7) Each fitting hole 36 is disposed in an arc shape in a regular interval (pitch) so as to follow the track of each protrusion 29 when each lever member 27 is rotated about the shaft 26 of each cam 24. Therefore, since the lever member 27 is rotated and the protrusion 29 of the lever member 27 is selectively fitted to any one of the fitting holes 36, the rotation angle of the cam 24 about the shaft 26 can be changed in stages.

### Modified Embodiment

In addition, the above-described embodiment may be modified to other embodiments as described below.

At least one of the rotary cams 24 may be modified to a slide type cam.

Any one of two side walls other than the side walls of both sides in the axis direction of each cam 24 may be omitted.

Each cam 24 is not necessarily disposed on the outside of the nozzle forming area R in the direction (the up-down direction) which is perpendicular to the nozzle forming area R.

The axis direction of each cam 24 may be the same as each other.

In the peripheral wall 16c of the carriage 16 in which each bearing portion 32 is installed and each bearing plate 33 in which the bearing portion 34 is installed, the surface of each cam 24 side of the peripheral wall 16c and each bearing plate 33 does not necessarily come close to the surface (the outer peripheral surface) in which each shaft 26 is installed in each cam 24.

Each boss portion 37 is not necessarily disposed so that the outer peripheral surface of each boss portion 37 comes close to the side walls of both sides in the axis direction of each cam 24 in the inside of each cam 24.

The three cams 24, which support the recording head unit 20, may be linearly lined up in planar view. In this case, the angle adjustment of the recording head unit 20 is limited.

As the recording medium, a plastic film, cloth, a thin metal sheet, or the like may be used instead of the recording sheet P.

The recording sheet P may be a sheet paper (single paper sheet) or a continuous form paper.

The ink jet type printer 11 may be a so-called line head printer in which a recording head is fixed so as to not be moved and ink is ejected to a recording sheet which is transported to under the recording head.

In the embodiments and modified embodiments, the recording apparatus is exemplified by the ink jet type printer 11. However, the recording apparatus may adopt a liquid ejecting apparatus in which liquid other than ink is ejected or discharged. That is, the recording apparatus may be used in various liquid ejecting apparatuses including a liquid ejection head, and the like, which eject minutely small amount of liquid droplets. Further, the liquid droplet designates a liquid state ejected from the liquid ejecting apparatus, and therefore, may include granular, tear-shaped, threadlike trailed droplets. Also, the liquid described herein may be any material in which the liquid ejecting apparatus can eject. For example, the liquid is preferable if the material is a liquid phase, and the liquid may include not only a liquid-state material having a high or low viscosity, sol, gel water, other inorganic solvent, an organic solvent, a solution, a liquid-state resin, a liquid in flowable condition such as liquid-state metal (molten metal), or a liquid as one state of a substance, but also materials in which particles of a functional material including a solid material such as a pigment or a metal particle are dissolved, dispersed to, or mixed with a solvent, and the like. Further, as described in the embodiments and the modified embodiment, the ink or liquid crystals, and the like may be exemplified as representative example of the liquid. Here, the ink includes a general water-based ink and an oil-based ink, various liquid compositions such as a gel ink, a hot melt ink or the like. As the detailed examples of the liquid ejecting apparatus, for example, there may be as follows: a liquid ejecting apparatus for ejecting a liquid including a material such as a distributed or a dissolved electrode material or color material which is used for manufacturing a liquid crystal display, EL (electro-luminescence) display, a surface luminescence display, and a color filter; a liquid ejecting apparatus for ejecting a bioorganic material used in the manufacture of a bio chip; a liquid ejecting apparatus for ejecting a liquid including a sample used as a precision pipette; a printing apparatus; a micro-dispenser; or the like. Moreover, the liquid ejecting apparatus may include; a liquid ejecting apparatus for ejecting of lubricant from a pinpoint to a precision machine such as a watch or a camera; a liquid ejecting apparatus for ejecting a transparent resin liquid such as UV curing resin onto a substrate in order to form a minute hemispherical lens (an optical lens) or the like used in an optical communication element or the like; and a liquid ejecting apparatus for ejecting an etching liquid such as an acid liquid or an alkali liquid in order to etch a substrate or the like. In addition, the aspects of the invention may be applied to any one of the above-described liquid ejecting apparatuses.

What is claimed is:

1. A position adjustment mechanism that adjusts a position of a second member with respect to a first member, the position adjustment mechanism comprising:
a cam that is provided in the first member so that a cam surface of the cam abuts the second member; and
a fixing portion that is provided in a forming area of the cam surface in the first member and fixes the second member to the first member by screw in a state where the position of the second member with respect to the first member is adjusted by the cam.

2. The position adjustment mechanism according to claim 1,
wherein three cams are provided, and
each cam is disposed so as to line up in a non-liner shape in positions which are different to each other in the first member.

3. The position adjustment mechanism according to claim 1,
wherein the cam is annularly formed, and
the fixing portion is disposed so that an outer peripheral surface of the fixing portion comes close to an inner peripheral surface of the cam.

4. The position adjustment mechanism according to claim 1,
wherein the cam is annularly formed and a rotary cam which is rotated about a shaft installed so as to cross to an axis direction of the screw in the outer peripheral surface of the cam,
the position adjustment mechanism further comprises a bearing portion that is installed in the first member and supports the shaft, and
the bearing portion is disposed so that a surface of the cam side comes close to the outer peripheral surface of the cam.

5. A recording apparatus comprising:
the position adjustment mechanism according to claim 4; and
a recording portion that performs a recording processing on a recording medium which is transported from an upstream side toward a downstream side,
wherein the first member constitutes a carriage that is moved in a scanning direction intersecting the transport direction of the recording medium, and the second member constitutes the recording portion,
each cam is disposed at two positions that are separated along the scanning direction on the upstream side of the transport direction in the carriage, and at one position between the two positions in the scanning direction at the downstream side in the transport direction in the carriage, and
the shafts of the cams disposed in the two positions are extended along the scanning direction, and the shaft of the cam disposed in the one position is extended along the transport direction.

6. The recording apparatus according to claim 5,
wherein the recording portion includes a nozzle forming area of a plane shape in which the nozzle is formed so as to eject a liquid to the recording medium, and
each cam is disposed on the outside of the nozzle forming area in a direction crossing the nozzle forming area.
